(19) United States
(12) Patent Application Publication
(10) Pub. No.: US 2008/0005910 A1
(43) Pub. Date: Jan. 10, 2008

(54) Cable cutter

(75) Inventor: Chih Yaun Hsiao, Tucheng City (TW)

Correspondence Address: TROXELL LAW OFFICE PLLC, SUITE 1404, 5205 LEESBURG PIKE, FALLS CHURCH, VA, 22041, US

(73) Assignee: LIFU Bicycle Co., Ltd.

(21) Appl. No.: 11/710,585

(22) Filed: Feb. 26, 2007

(30) Foreign Application Priority Data
Mar. 10, 2006 (TW) 95203990

(51) Int. Cl. B26B 27/00

(52) U.S. Cl. 30/252

(57) ABSTRACT

A cable cutter includes two jaws mutually turnably connected together via a pivot and being provided near respective front inner ends with two opposite cutting edges; two handles being separately fixedly connected to rear ends of the two jaws with a restoring spring connected to and between the two handles; and a restorer being provided on an outer side of one of the two jaws and surrounded by a protective cup. An end of the cable cut with the cutter and become flattened may be pressed against a tip of the restorer to be restored to an original round cross section. The protective cup has an open top higher than the tip of the restorer, protecting a user's hand against accidental injury by the tip of the restorer and making the cable cutter safer for use.

### FIELD OF THE INVENTION

The present invention relates to a cable cutter, and more particularly to a cable cutter with a restorer provided thereon for restoring a cut and flattened cable end to an original round cross section.

### BACKGROUND OF THE INVENTION

Before assembling a brake cable to a bicycle, the brake cable must be cut with a cable cutter to a desired length. Then, the assembled cable must be tightly stretched for a brake shoe connected to a terminal of the brake cable to function normally and thereby ensure a rider's safety in riding.

When a brake cable 20 is cut using a conventional cable cutter, the jaws of the cable cutter would inward squeeze the cable 20 to flatten a hollow inner tube 21 thereof, as shown in FIG. 3. The flattened brake cable 20 could not be easily extended through necessary parts on the bicycle during assembling thereof, and has reduced braking function. Therefore, it is necessary to use another restoring tool to expand the flattened inner tube 21 of the cable 20 before the cable 20 is assembled to the bicycle. This would inevitably complicate and require more time to complete the assembling of the brake cable 20. The additional restoring tool also increases the bicycle manufacturer's equipment cost.

There is another conventional cable cutter, on which a blade-shaped restoring device is provided. A user may directly pull the restoring device open from the cable cutter to conveniently restore the cable 20 and the inner tube 21 thereof cut and flattened by the cable cutter. However, the user tends to be accidentally injured by the blade-shaped restoring device when trying to expand the flattened cable 20 with the restoring device.

Therefore, it is desirable to develop an improved cable cutter that has a restorer directly provided thereon, so as to enable efficient expansion of a flattened cable without injuring a user.

### SUMMARY OF THE INVENTION

A primary object of the present invention is to provide an improved cable cutter that has two pivotally connected jaws with two opposite cutting edges for cutting a cable.

Another object of the present invention is to provide an improved cable cutter that is provided on one of two jaws with a restorer for conveniently restoring a cut and flattened cable end to an original round cross section to function normally.

A further object of the present invention is to provide an improved cable cutter that is provided with a restorer surrounded by a protective cup, so as to protect a user against accidental injury by a tip of the restorer when the user is restoring a cut and flattened cable end with the restorer.

To achieve the above and other objects, the cable cutter according to the present invention includes two jaws mutually turnably connected together via a pivot and being provided near respective front inner ends with two opposite cutting edges; and two handles being separately fixedly connected to rear ends of the two jaws with a restoring spring connected to and between the two handles. The cable cutter is characterized in a restorer provided on an outer side of one of the two jaws and surrounded by a protective cup.

In an embodiment of the present invention, one of the two handles of the cable cutter is provided at a rear end opposite to the jaws with a retaining ring to normally hold the two jaws of the cable cutter in a closed position.

When an end of the cable cut with the cutter becomes flattened, a user may conveniently press the flattened cable end against a tip of the restorer to expand and thereby restore the flattened cable to an original round cross section. The user needs not to change to another hand tool for restoring the flattened cable, making the cutting of a cable easier and more efficient.

The protective cup has an open top higher than the tip of the restorer, and therefore protects a user's hand against accidental injury by the tip of the restorer and makes the cable cutter safer for use.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a cable cutter according to a preferred embodiment of the present invention;

FIG. 2 is a top view of the cable cutter of the present invention;

FIG. 3 is a cross-sectional view of a deformed and flattened cable having been cut using a cable cutter;

FIG. 4 shows the use of a restorer on the cable cutter of the present invention to restore a cut and flattened cable;

FIG. 5 is a partially enlarged sectional view of FIG. 4 showing the flattened cable is approached toward the restorer on the cable cutter of the present invention;

FIGS. 6 and 7 show the flattened cable of FIG. 5 is further pressed against the restorer of the present invention;

FIG. 8 shows the cable is restored and removed from the restorer; and

FIG. 9 is a cross-sectional view of around cross section of the cable having been fully restored using the restorer on the cable cutter of the present invention.

### DETAILED DESCRIPTION OF THE PREFERRED EMBODIMENTS

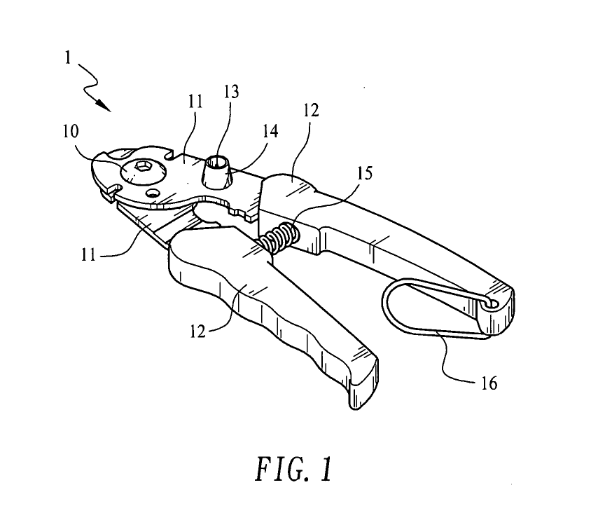

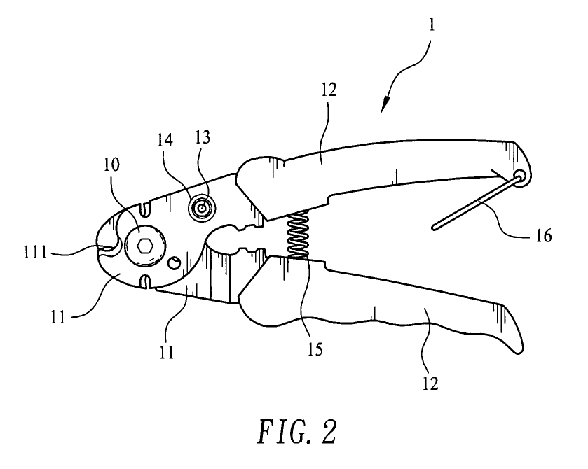

Please refer to FIGS. 1 and 2 that are perspective and top views, respectively, of a cable cutter 1 according to a preferred embodiment of the present invention. As shown, the cable cutter 1 includes two jaws 11 mutually turnably connected together via a pivot 10. The two jaws 11 are provided near respective front inner ends with a cutting edge 111, so that the two cutting edges 111 face each other. Two handles 12 are separately fixedly connected to rear ends of the two jaws 11. A restoring spring 15 is connected to and between the two handles 12.

One of the two jaws 11 is provided on an outer side at a predetermined position with a restorer 13. A protective cup 14 is located around the restorer 13 with an open top of the protective cup 14 higher than a tip of the restorer 13.

In an embodiment of the present invention, one of the two handles 12 is provided at a rear end opposite to the jaws 11 with a retaining ring 16. When the cable cutter 1 is not in use, the retaining ring may be put around a rear end of the other handle 12, so as to normally hold the two jaws 11 in a mutually closed position without dangerously exposing the cutting edges 111. Therefore, the cable cutter 1 may be safely carried or stored.

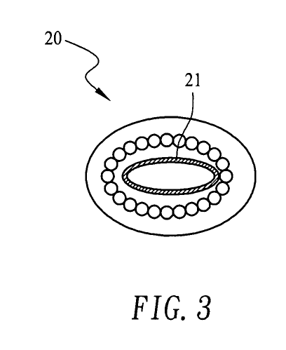

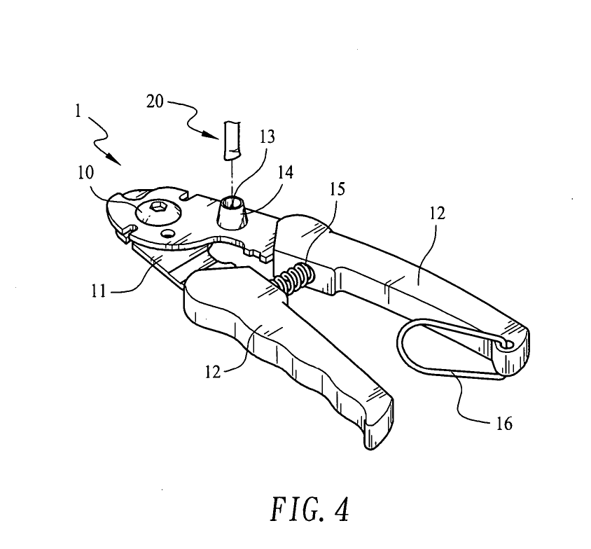

Please refer to FIG. 4. A cable 20 may be cut to a desired length using the two cutting edges 111 at the two jaws 11 of the cable cutter 1. The cable 20 and an inner tube 21 thereof are squeezed and flattened near where the cable 20 is cut, as shown in FIG. 3.

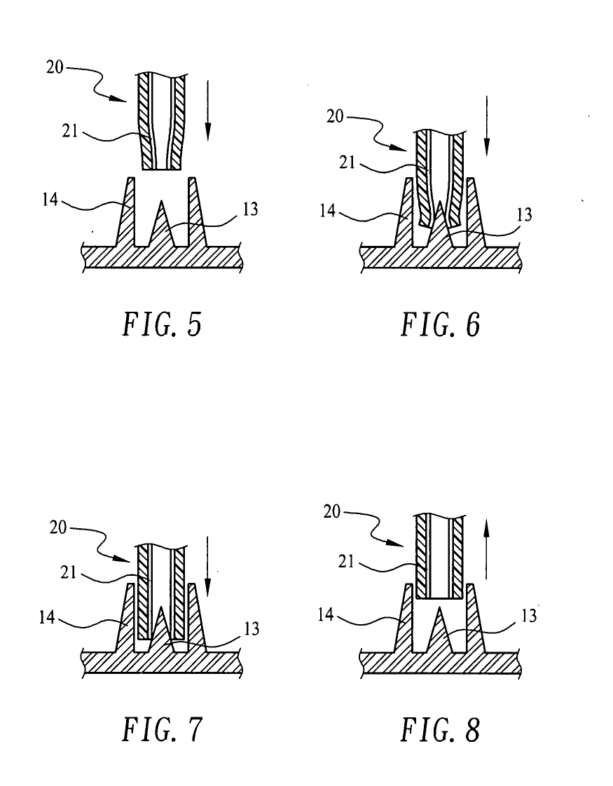

Please refer to FIG. 4 along with FIGS. 5, 6, and 7. To restore the flattened cable 20, simply approach the flattened end of the cable 20 toward the restorer 13 in the protective cup 14, both of which are provided on the cable cutter 1, as shown in FIGS. 4 and 5. When the cable 20 is aligned with and further pressed against the restorer 13 in a direction as indicated by the arrow, a tip of the restorer 13 would gradually enter into the flattened inner tube 21 of the cable 20 to expand the inner tube 21 and restore the cable 20, as shown in FIGS. 6 and 7. When the flattened cable 20 has been completely restored to have a round cross section, it may be pulled out of the protective cup 14 for use, as shown in FIG. 8.

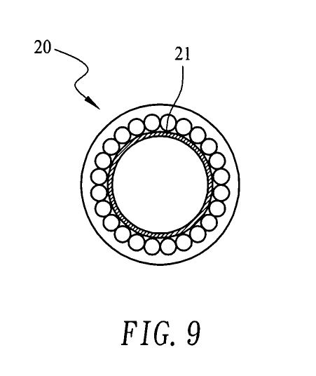

FIG. 9 is a cross-sectional view of the cable 20 that has been restored using the restorer 13. As shown, the flattened cable 20 as shown in FIG. 3 has returned to its original round cross section, and can therefore provide its designed function.

With the restorer 13 directly provided on one jaw 11 of the cable cutter 1, a user may economically and conveniently restore the cut and flattened cable 20 to a round cross section without the need of buying and changing between different hand tools or involving in complicate and bothersome operating procedures to adversely affect the working efficiency. The protective cup 14 located around the restorer 13 also protects the user against injury by the tip of the restorer 13, making the cable cutter 1 safer for use. Moreover, the cable 20 having been restored to the round cross section using the restorer 13 may still work normally.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A cable cutter, comprising two jaws mutually turnably connected together via a pivot and being provided near respective front inner ends with two opposite cutting edges; two handles being separately fixedly connected to rear ends of the two jaws; and a restorer being provided at a predetermined position on an outer side of one of the two jaws.

2. The cable cutter as claimed in claim 1, wherein the restorer is surrounded by a protective cup, and the protective cup having an open top higher than a tip of the restorer.

3. The cable cutter as claimed in claim 1, further comprising a restoring spring connected to and between the two handles.

4. The cable cutter as claimed in claim 1, wherein one of the two handles is provided at a rear end opposite to the jaws with a retaining ring.
